(19) United States
(12) Patent Application Publication
(10) Pub. No.: US 2006/0231219 A1
(43) Pub. Date: Oct. 19, 2006

(54) End filling for a winding shaft of a curtain

(75) Inventor: Ming Nien, Taichung (TW)

Correspondence Address: TROXELL LAW OFFICE PLLC, SUITE 1404, 5205 LEESBURG PIKE, FALLS CHURCH, VA, 22041, US

(73) Assignee: Nien Made Enterprise Co., Ltd.

(21) Appl. No.: 11/106,587

(22) Filed: Apr. 15, 2005

(51) Int. Cl. E06B 9/17

(52) U.S. Cl. 160/323.1

(57) ABSTRACT

An end filling for a winding shaft of a curtain is inserted in an end of a winding shaft of a winding curtain for supporting the inner wall of the end so that the wind shaft may not twist or disfigure during cutting process

### BACKGROUND OF THE INVENTION

1. Field of the Invention

This invention relates to a curtain, particularly to an end filling for a winding shaft of a curtain or for an upper frame of a Venetian blind for preventing the winding shaft or the upper frame from twisting or disfiguring during cutting process.

2. Description of the Prior Art

Conventional common curtains or Venetian blinds are used for adjusting brightness in a room for both keeping privacy of a home and beautifying the room at the same time. Common winding shafts used in the curtains generally wind the curtain cloth possible to be wound on or released out and having and an end closed up by an end cap, and the other end provided with a winging device including a bead-chain for controlling winding up and down the curtain cloth. In case of a Venetian blind, it has an upper frame with two ends respectively closed up by an end cap, and all strip of the blind are pulled up or down by a rope extending through the strips for spreading or collapsing them.

However, the winding shafts or the upper frame are almost made of paper, plastic, or metal having low strength to resist disfiguring caused by diametrical pressure, so they are liable to twist or disfigure during cutting process, even if cut with carefulness.

### SUMMARY OF THE INVENTION

This invention offers an end filling for a winding shaft of a curtain or for an upper frame of a Venetian blind, and the end filling inserted in an end of a winding shaft of a winding curtain or an upper frame of a Venetian blind, so the inner wall of that end may be supported so that the wind shaft or the upper frame may not twist or disfigure during cutting process.

### BRIEF DESCRIPTION OF DRAWINGS

This invention will be better understood by referring the accompanying drawings, wherein:

FIG. 1 is a front view of a winding curtain using an end filling for a winding shaft in the present invention;

FIG. 2 is a partial exploded perspective view of the winding curtain using an end filling for a winding shaft in the present invention;

FIG. 3 is a perspective view of a first embodiment of an end filling for a winding shaft in the present invention;

FIG. 4 is a cross-sectional view of a second embodiment of an end filling or winding shaft in the present invention;

FIG. 5a is a lengthwise cross-sectional view of the second embodiment of an end filling fitted in a winding shaft in the present invention;

FIG. 5b is a diametrical cross-sectional view of a third embodiment of an end filling fitted in a winding shaft in the present invention;

FIG. 5c is a lengthwise cross-sectional view of a fourth embodiment of an end filling fitted in a winding shaft in the present invention;

FIG. 5d is a lengthwise cross-sectional view of a fifth embodiment of an end filling fitted in a winding shaft in the present invention;

FIG. 5e is a diametrical cross-sectional view of a sixth embodiment of an end filling fitted in a winding shaft in the present invention;

FIG. 6 is a perspective view of a Venetian blind provided with an end filling in an upper frame in the present invention; and,

FIG. 7 is an exploded perspective view of an end filling for an upper frame of a Venetian blind in the present invention.

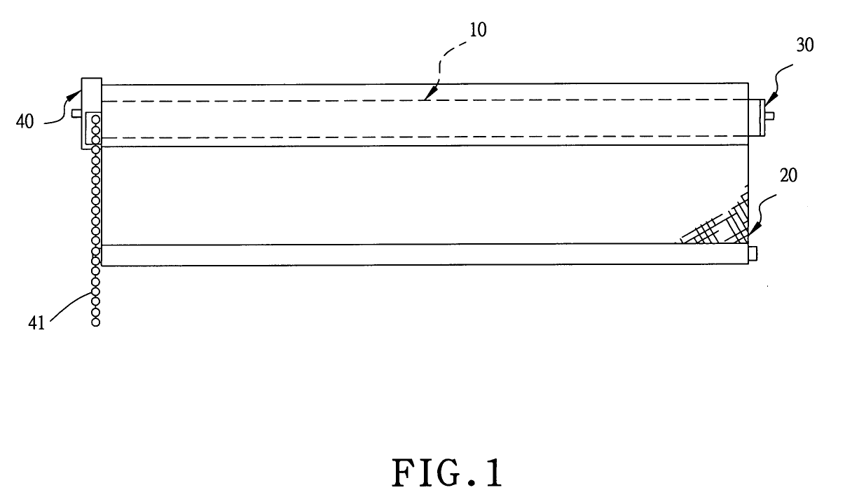

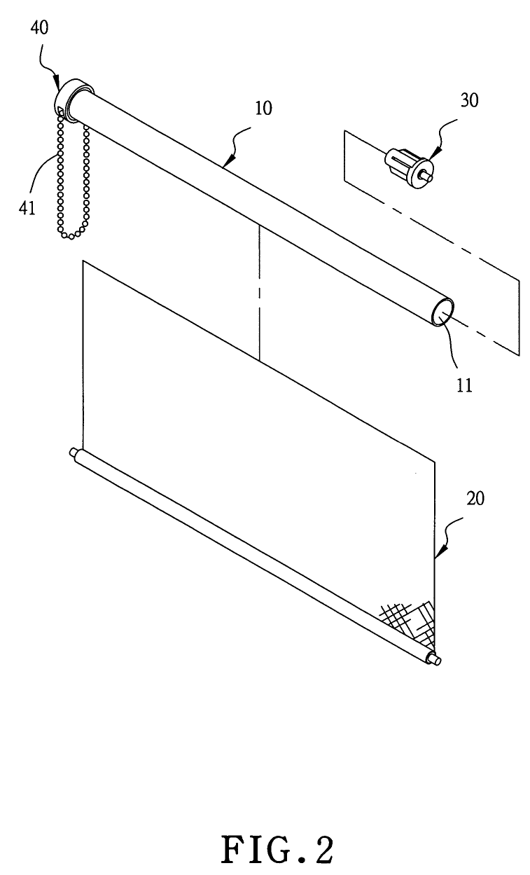

### DETAILED DESCRIPTION OF THE PREFERRED EMBODIMENTS

A first embodiment of a end filling a winding shaft of a curtain is applied to a wind curtain, including a winding shaft 10 for winding a curtain cloth 20, an end cap 30 closing up one end of the winding shaft 10, a winding device 40 fixed on the other end of the wind shaft 10 to rotate the wind shaft 10 for winding up and down the curtain cloth 20, and an end less bead chain 41 extending around the winding device 40, and an end filling 50.

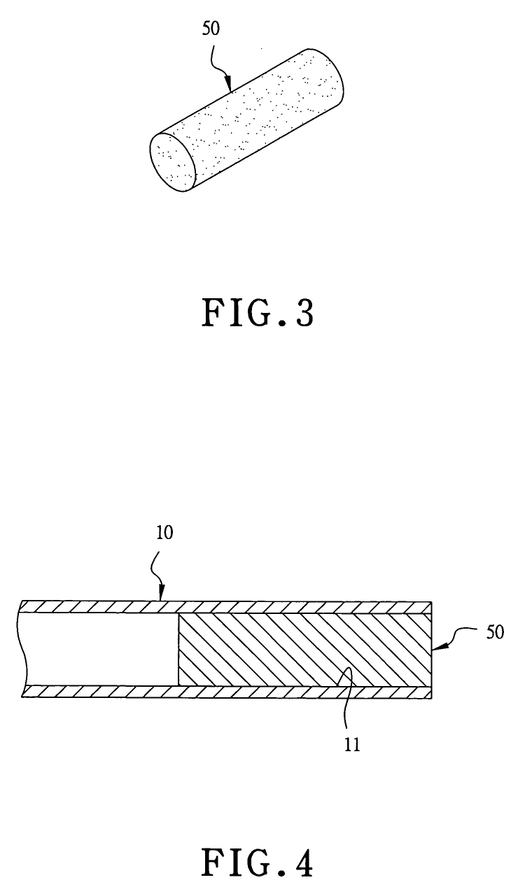

The end filling 50, as shown in FIGS. 3 and 4, is solid and of a round column shape, longer than the part of the wind shaft 10 to be cut off its material, having a diameter almost the same as the inner diameter of the winding shaft 1 0, and made of plastic, metal or other materials with a hardness a little high than the winding shaft 10. The end filling 50 fits in the interior of one end of the winding shaft 10, clogging up the interior of the end of the winding shaft 10 to be cut off the material so that the portion of the wind shaft 10 may be supported, not twisting or disfiguring during cutting process and after cut off.

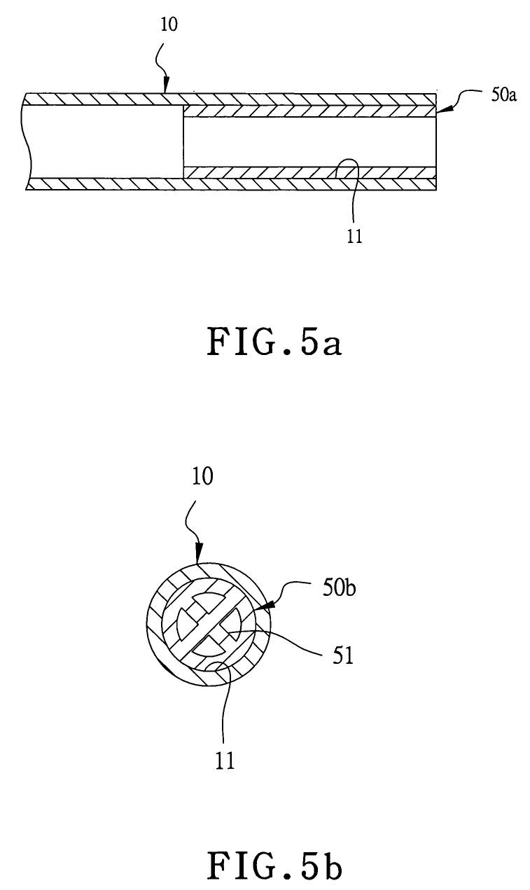

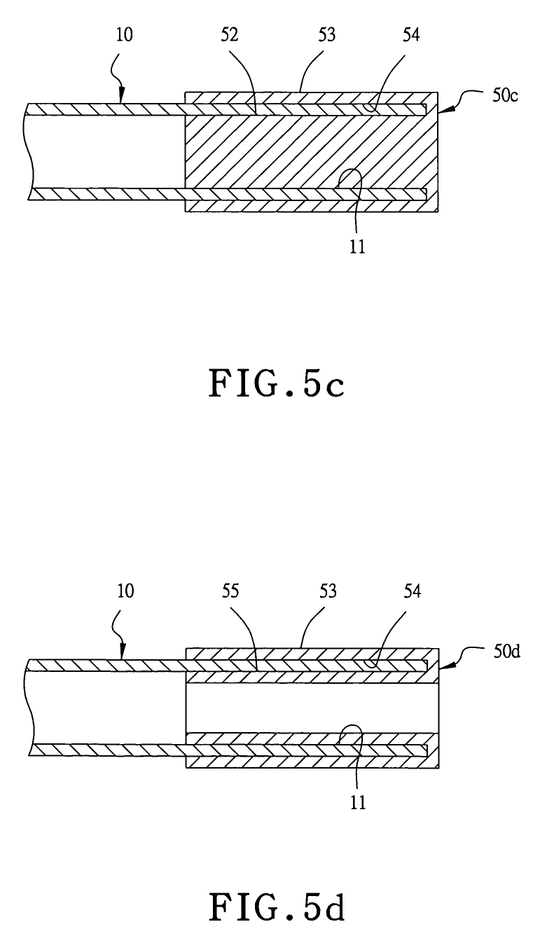

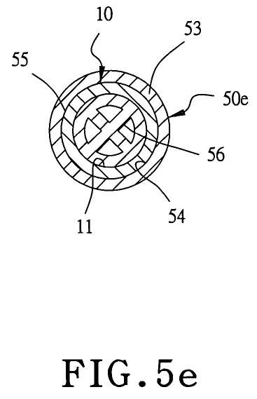

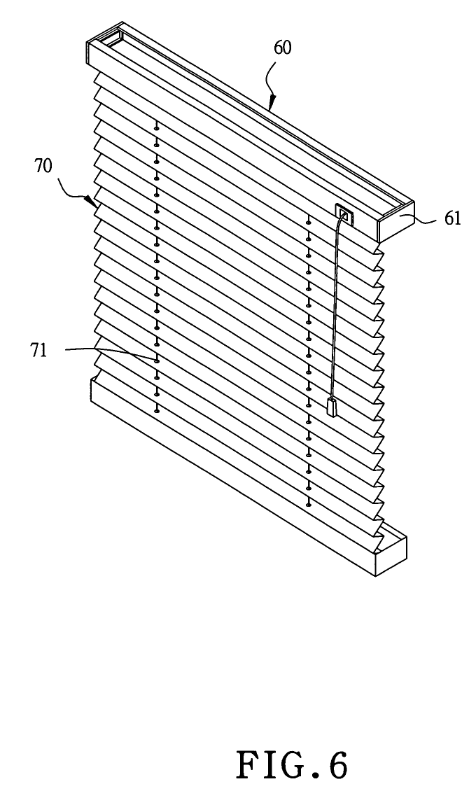

Next, a second embodiment of an end filling 50a for a winding shaft 10 is shown in FIG. 5a, having a hollow interior, and a third embodiment of an end filling 50b for an winding shaft 10 is shown in FIG. 5b, having additionally a cross-shaped rib 51 in its hollow interior.

Further, FIG. 5c shows a fourth embodiment of an end filling 50c for a winding shaft 10, consisting of a solid column portion 52 in the center, an annular wall portion 53 connected with the solid column portion 52 25 and separated by an annular groove 54 formed between the solid column portion 52 and the annular wall portion 53 fitting around the outer annular surface of the end of a winding shaft 10.

Moreover, FIG. 5d shows a fifth embodiment of an end filling 50d for a winding shaft 10, consisting of a hollow tube portion 55, an annular wall portion 53 connected with the tube portion 55, and an annular groove 54 defined between the tube portion 55 and the wall portion 53, with the annular groove 54 for the annular wall 11 of the end of the winding shaft 10 to fit in securely.

Further, FIG. 5e shows a sixth embodiment of an end filling 50e, which is consisted of a hollow tube portion 55, a cross-shaped rib 56 formed in the hollow interior of the tube portion 55, an annular wall portion 53 connected with the tube portion 55, an annular groove 54 defined between the tube portion 55 and the annular wall portion 53, with the annular wall 11 of the winding shaft 10 fitting in the annular groove securely.

Next, how to use the end fillings for a winding shaft 10 is to be described as below.

Firstly, if the first embodiment of the end filling 50 fitted in an end of a winding shaft 10 is about to be cut off its material, an end cap 30 closed on an end of the wind shaft 10 is in advance taken off to let the end exposed out. Then the end filling 50 is pushed into the hollow interior of the end of the winding shaft 10, supporting the inner wall 11 of the winding shaft 10, and then the end of the winding shaft 10 is cut off the material, with the end filling 50 also cut off together at the same time. Then the rest of the end filling 50 remained in the end of the cut wind shaft 10 may or may not pulled out, and the end cap 30 is immediately closed up the end to push the remained end filling 50 further into the hollow interior, if not pulled out, finishing cutting process.

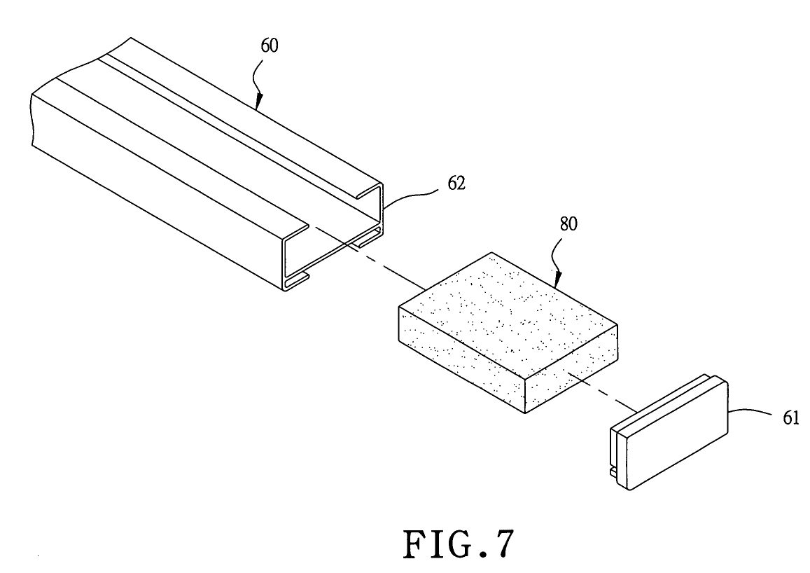

In addition, referring to FIGS. 6 and 7, the end filling in the inventin can be applied to a Venetian blind, which is provided with a hollow upper frame 60. The upper frame 60 is generally shaped rectangular, having two ends closed up with an end cap 61, with a rope 71 lengthwise extending through plural blind strips 70 for pulling up or lowering down them.

An end filling 80 of a solid column shape in accordance with the upper frame 60 is further provided to be inserted in the hollow interior of the end of the upper frame 60, having a length longer than that of the upper frame 60 to be cut, with its width being almost the same as the inner width of the upper frame 60, and made of plastic, metal or other materials with the hardness a little higher than that of the upper frame 60. Then the inner wall 62 of the end of the upper frame 60 is supported by the end filling 80, so the upper frame 60 may not twist or disfigure during cutting process and after cut off to the needed length.

By the way, it is necessary to mention that the end filling 80 for a Venetian blind can also have various embodiments, being hollow or solid, possible to have a reinforcing rib in its hollow interior or an annular wall separated by an annular groove from a solid center column so as to let the annular wall of the upper frame inserted in the annular groove. Thus a user can choose one of different embodiments, which can be applied to a Venetian blind.

Lastly, the invention has the following advantages.
1. The end filling 50 or 80 can support the inner wall 11 or 62 of the end of a wind shaft 10 of a winding curtain or an upper frame 60 of a Venetian blind, beefing up resistant strength against twisting or disfiguring during cutting process, enabling cutting carried out smoothly.
2. The material for the end filling 50 or 80 is not limited specially, having hardness a little higher than that of the wind shaft 10 or the upper frame, so a wide variety of materials are available.
3. The end filling 50 or 80 can have various structures, if it has sufficient strength for supporting the inner wall of the winding shaft 10 or the upper frame 60.

While the preferred embodiments of the invention have been described above, it will be recognized and understood that various modifications may be made therein and the appended claimed are intended to cover all such modifications that may fall within the spirit and scope of the invention.

What is claimed is:

1. A end filling for a winding shaft of a curtain, said curtain being a winding curtain having a winding shaft, said winding shaft being hollow and having one end closed up with an end cap, and characterized by:
An end filling clogging up the interior of the end of said winding shaft, an inner annular wall of said winding shaft being supported by said end filling during the end of said winding shaft being cut off its material.

2. The end filling for a winding shaft of a curtain as claimed in claim 1, wherein said end filling is made of plastic.

3. The end filling for a wind shaft of a curtain as claimed in claim 1, wherein said end filling is made of metal.

4. The end filling for a wind shaft of a curtain as claimed in claim 1, wherein said end filling has hardness higher than that of said wind shaft.

5. The end filling for a winding shaft of a curtain as claimed in claim 1 , wherein said end filling is a solid column.

6. The end filling for a winding shaft for a curtain as claimed in claim 1, wherein said end filling is a circular hollow tube.

7. The end filling for a wind shaft of a curtain as claimed in claim 1, wherein said end filling is a hollow tube provided with a rib formed in its hollow interior.

8. The end filling for a winding shaft of a curtain as claimed in claim 1, wherein said end filling is consisted of a solid column fitting in the hollow interior of said wind shaft, an annular wall formed outside of said solid column and connected with said solid column, and an annular groove defined between said annular wall and said solid column, and the annular wall of said winding shaft fits in said annular groove securely.

9. The end filling for a winding shaft of a curtain as claimed in claim 1, wherein said end filing is consisted of a circular hollow tube portion to fit in the interior of said wind shaft, an annular wall portion connected with said hollow tube portion and located outside of said hollow tube portion, an annular groove formed between said hollow tube portion and said annular wall portion for the annular wall of said winding shaft to fit therein securely.

10. The end filling for a winding shaft of a curtain as claimed in claim 1, wherein end filling is consisted of a hollow tube portion to fit in the hollow interior of said winding shaft, a reinforcing rib is formed in the hollow interior of said hollow tube portion, an annular wall portion is formed outside of said hollow tube and connected with said hollow tube, an annular groove is formed between said annular wall portion and said hollow tube portion for the annular wall of said winding shaft to fit therein securely.

11. An end filling for an upper frame of a Venetian blind, said Venetian blind having an upper frame, an end cap closed up on an end of said upper frame, and characterized by:
An end filling inserted in the interior of the end of said upper frame, the inner wall of said end of said upper frame supported by said end filling during cutting process of the end of said upper frame off its material for preventing said upper frame from twisting or disfiguring.

12. The end filling for an upper frame of a Venetian blind as claimed in claim 11, wherein said end filling is made of plastic.

13. The end filling for an upper frame of a Venetian blind as claimed in claim 11, wherein said end filling is made of metal.

14. The end filling for an upper frame of a Venetian blind as claimed in claim 11, wherein said end filling has hardness higher than that of said upper frame.

15. The end filling for an upper frame of a Venetian blind as claimed in claim 11, wherein said end filling is solid.

16. The end filling for an upper frame of a Venetian blind as claimed in claim 11, wherein said end filling is a hollow tube.

17. The end filling for an upper frame of a Venetian blind as claimed in claim 11, wherein said end filling is a hollow tube with a reinforcing rib formed in its hollow interior.
